(19) United States
(12) Patent Application Publication
(10) Pub. No.: US 2007/0037578 A1
(43) Pub. Date: Feb. 15, 2007

(54) Method and system for dynamically modifying a dial plan for a wireless dual-mode handset

(76) Inventor: John Besterman, Suwanee, GA (US)

Correspondence Address: ARRIS INTERNATIONAL, INC, 3871 LAKEFIELD DRIVE, SUWANEE, GA, 30024, US

(21) Appl. No.: 11/502,272

(22) Filed: Aug. 10, 2006

Related U.S. Application Data
(60) Provisional application No. 60/706,968, filed on Aug. 10, 2005.

(51) Int. Cl. H04Q 7/20

(52) U.S. Cl. 455/445

(57) ABSTRACT

A dual mode device detects when its presence within a home wireless LAN. The dual mode device sends a message containing the BSSID of the HWLAN to an application on a WWC server, which associates the BSSID with the subscriber's identity in a dynamic database. When a call is dialed to the dual mode device, the WWC server application determines that the dual mode device is within the HWVLAN and causes the dual mode device and the HWLAN devices to ring. If a call is dialed to the HWLAN, the WWC server application looks up in a static database the user identity associated with the HWLAN and determines that the user subscribes to dynamic modification of the dial plan. The dynamic database, indexed on identity, is searched and determines that the user is within their HWLAN. Therefore, the dual mode device also rings when the HWLAN devices ring.

### CROSS REFERENCE TO RELATED APPLICATION

This application priority under 35 U.S.C. 119(e) to U.S. provisional patent application No. 60/706,968 entitled “Converged VoWLAN and POTS,” which was filed Aug. 10, 2005, and is incorporated herein by reference in its entirety.

### FIELD OF THE INVENTION

The present invention relates generally to communication devices, and more particularly to facilitating the use of a dual-mode wireless handset.

### BACKGROUND

Cable data systems are used to allow cable TV subscribers use the Hybrid-Fiber-Coax network as a communication link between their home networks and the Internet. As a result, computer information (Internet Protocol packets) can be transmitted across the Hybrid-Fiber-Coax network between home computers and the Internet. The DOCSIS specification (defined by CableLabs) specifies the set of protocols that must be used to effect a data transfer across the Hybrid-Fiber-Coax network. Two fundamental pieces of equipment permit this data transfer: a cable modem (CM) which is positioned in the subscriber's home, and a Cable Modem Termination System (CMTS) which is positioned in the head end of the cable TV company.

In addition to data traffic, subscribers are more and more obtaining telephony voice services over networks other than the traditional public switched telephony network (“PSTN”). A multiple services operator (“MSO”) may provide such telephony services, in addition to data over cable service via DOCSIS. For example, CableLabs has established the PacketCable standard for providing telephony services over cable. A subscriber typically has a device that includes a DOCSIS cable modem for transmitting and receiving data and a media terminal adaptor (“MTA”) for processing voice traffic for transmission and reception over cable. The MTA, or embedded MTA (“EMTA”) known in the art, typically provides signals received from the cable network to the plain old telephone service (“POTS”) network in a user's home or office.

Not only do users obtain telephony services over cable, but many users also maintain a wireless telephone account for their cellular telephone, or similar device. Cellular telephones provide mobile access, whereas the service provided over cable is typically limited to the service address of the cable service. This can present a problem to a user when he or she is at the cable service address because there are two different telephone numbers an outside caller may use in attempting to reach the user. If the user carries a wireless device constantly but not a portable POTS device when inside the home or office served by the cable service, then a call to the POTS number would cause the user to scramble to reach the POTS phone. Or, if a user typically plugs in a cellular phone when returning home, for example, the ringing of the cellular phone may not be heard if the cellular device is charging out of the earshot of the user.

An emerging technology known as dual mode combines cellular and Wi-Fi radio communication in a single device. When a dual mode device is within range of a cellular network signal, it communicates with the corresponding cellular network. When the user and his or her dual mode device roam into a wireless LAN (“WLAN”), such as a WiFi LAN, the WLAN handles transport duties for signals to and from the dual mode device. Thus, voice call placed to the dual mode devices telephone number, will cause the dual mode device to ring whether transport is handled by the cellular network or the WLAN network. However, the problem of having different devices associated with different telephone numbers may still result in a call to the dual mode device causing it to ring, and a call placed to devices coupled to a home WLAN (“HWLAN”) causing these devices to ring exclusive of the dual mode device still exists.

Thus, there is a need for method and system that allows a call placed to either a cellular/dual mode device or a POTS device that corresponds to a HWLAN to cause both the cellular phone and the POTS devices at the HWLAN service location to ring and to handle the call, regardless of the device that the user chooses to pick up.

### BRIEF DESCRIPTION OF THE DRAWINGS

FIG. 1 illustrates a network environment for using a dual mode device in a home wireless LAN.

FIG. 2 illustrates a calls dialed to a dual mode device and to a wireless LAN.

FIG. 3 illustrates a system for detecting the presence of a dual mode device in a wireless LAN.

FIG. 4 illustrates a system for forking a called to one number to multiple devices corresponding to multiple numbers.

FIG. 5 illustrates a flow diagram of a method for detecting the presence of a dual mode device within the range of a wireless LAN.

FIG. 6 illustrates a flow diagram of a method for associating the dial plan of a dual mode device with the dial plan of a home wireless LAN.

FIG. 7 illustrates the database structure of a dynamic database and a static database.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

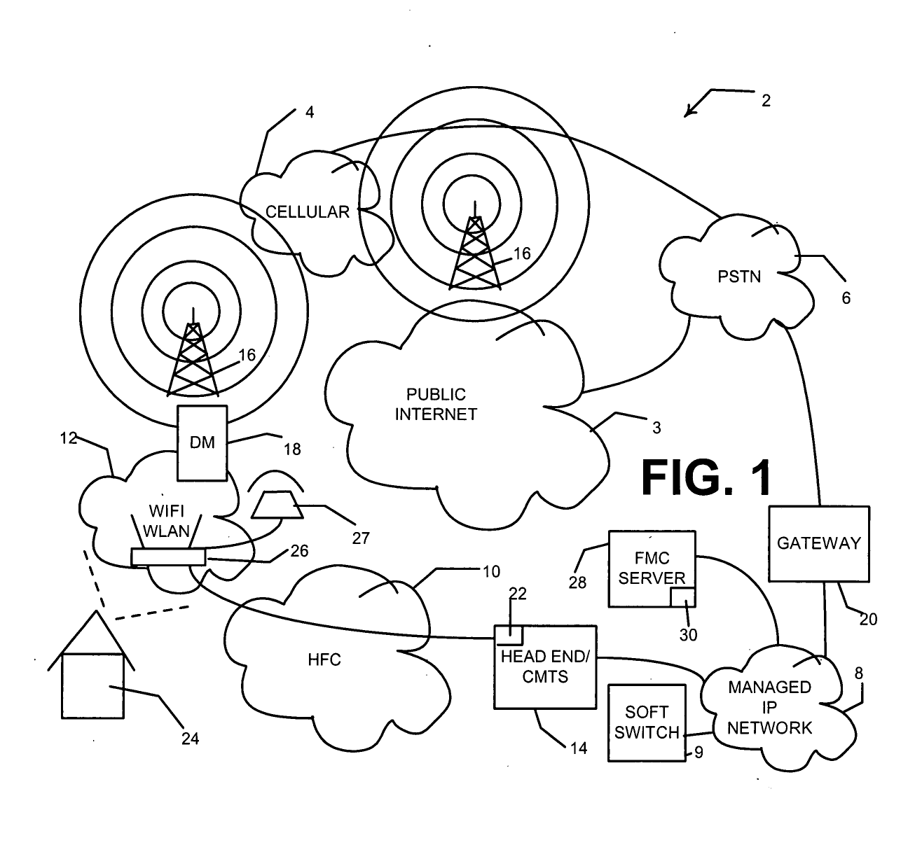

Turning now to FIG. 1, network architecture 2 is shown for providing communication services to subscribers. Network 2 comprises various subnetworks, including, but not limited to, the public internet 3, cellular telephone network 4, public switched telephony network (“PSTN”) 6, managed IP network 8, hybrid fiber coaxial (“HFC”) cable network 10 and wireless local area network (“WLAN”) 12. The various subnetworks are typically interconnected as shown in the figure, but other connection architectures are possible. For example, WLAN 12 is shown connected to public internet 2 via managed IP network 8 and HFC network 10. However, other means of transport between WLAN 12 and public internet 2 are possible, including broadband over power lines, for example, as known in the art. Furthermore, if other types of networks are used in place of HFC 10, then components, such as head end, CMTS 14 may not be used. Softswitch 9 is typically coupled to managed network 8, and manages, in conjunction with a gateway, call traffic between PSTN 6 and HFC 10.

Cellular network 4 includes one or more cell towers 16, which transmit and receive signals between the cellular network and wireless subscriber devices, such as, for example cellular telephones and dual mode devices 18, as known in the art. Cellular network 4 is typically coupled to PSTN, which may be coupled to public internet 2 and to managed IP network 8 via gateway 20, as known in the art. For purposes herein, call traffic over PSTN 6 and/or cellular network 4, which may involve activity from gateway 20 and softswitch 9, may be referred to as a call from/to PSTN 6 and/or cellular network 4 without explicit recitation of the mechanics of interoperation of gateway 20, softswitch 9, PSTN 6, or cellular network 4. As shown in FIG. 1 these components couple to managed IP network 8. Reference to call set up, signaling, tear down, etc., with a fixed mobile convergence server, as discussed in more detail below, is deemed to include messages to these components where appropriate, without specific recital of these steps or interaction of structure to the extent these steps or structure interaction are known in the art.

In the embodiment shown, a multiple services operator (“MSO”), a services provider, typically operates equipment located at a central location referred to as a head end. At the head end, CMTS 22 couples via HFC 10 to a cable modem device located at a subscriber's residential home, or premises 24. The cable modem device may be integrated into a wireless access point device 26, or coupled to a wireless access point via an Ethernet or universal serial bus (“USB”) connection, for example. The wireless access point device may use WiFi, WiMax, or other similar local wireless networking technology known in the art. For purposes herein, the WLAN device 26 is deemed to include the cable modem device and wireless access point device. Moreover, it will be appreciated the cable modem device typically includes a media terminal adaptor (“MTA”) or an embedded MTA (“EMTA”) which has a MAC address. The wireless networking portion typically has a separate MAC address, or BSSID, as will discussed in greater detail herein. WLAN device may be coupled to traditional plain old telephone service (“POTS”) devices 27 via subscriber line interface circuitry, as known in the art.

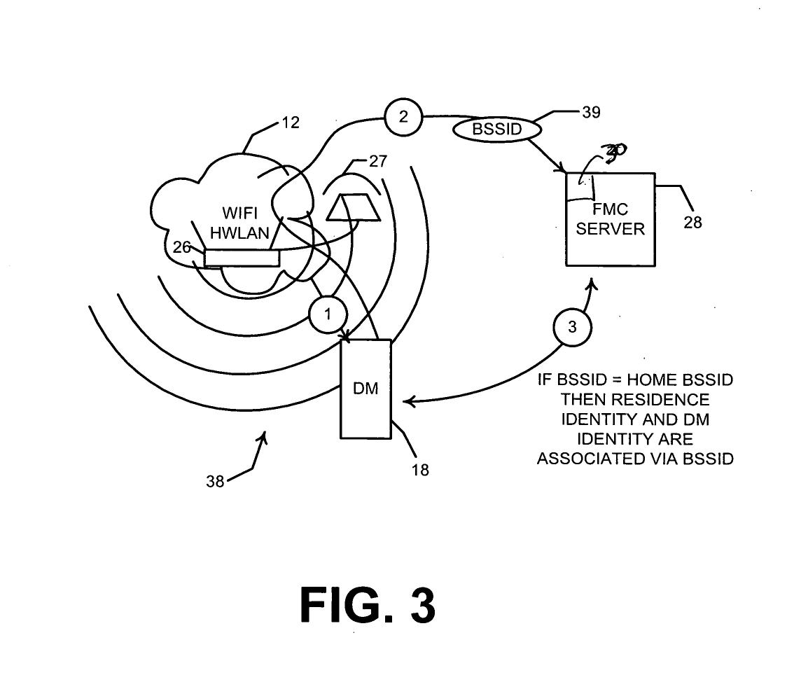

Fixed mobile convergence (“FMC”) server 28 is coupled to managed IP 8 network and typically administers call set-up, call tear-down and call traffic routing. It will be appreciated that reference herein to FMC server 28, which may include an application server, may include an implied reference to a separate application server 30, which may be referred to as a wireless wireline convergence (“WWC”) application server. The WWC application server includes and implements the aspects referred to herein in connection with description of FIGS. 3-7 below.

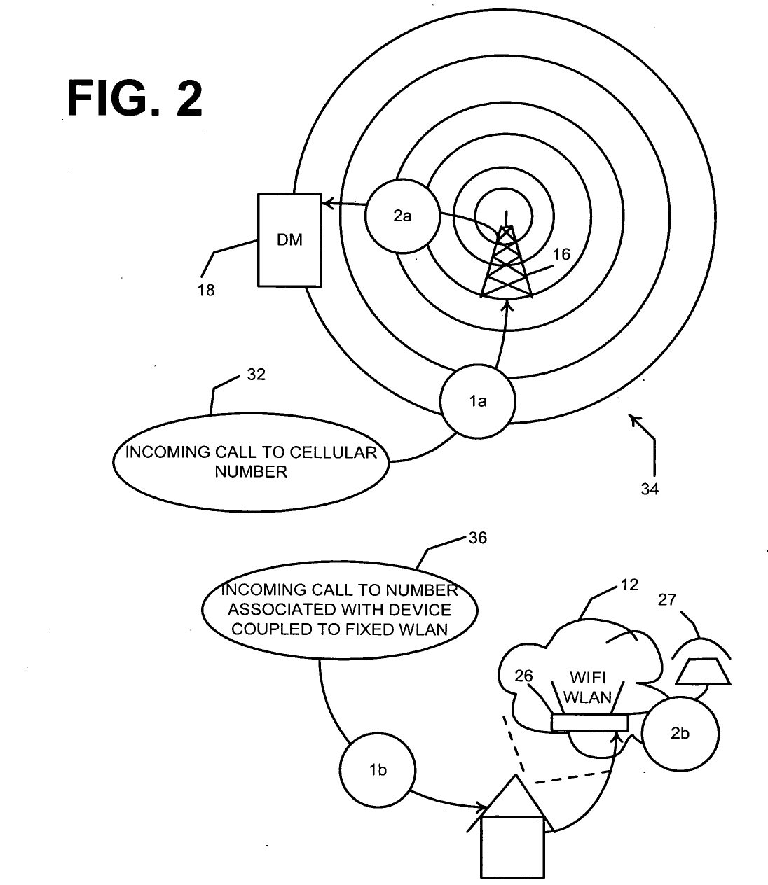

Turning now to FIG. 2, two scenarios are shown. In scenario a, a call is placed to a dual mode user device 18 that is located in the range 34 of cell tower 16. For clarity, the infrastructure related to placing the call, transporting the call and delivering the call message to the cell tower is not shown. These steps and related structure are represented by the encircled 1a in the figure. Since dual mode device 18 is within range 34 of cell tower 16, the call is forwarded from tower 16 to the dual mode device, as represented by encircled 2a. In scenario b, an incoming call 36 is placed to the telephone number associated with the residential home WLAN network 12. As with scenario a, the steps and related infrastructure associated with call initiation by the user, call set up, transport and delivery are represented by encircled 1b. Encircled 2b represents the forwarding of the call from WLAN device 26 to POTS device 27. The two scenarios shown in FIG. 2 illustrate the implementation of a dial plan arrangement when dual mode device 18 is not within the range of the WLAN 12.

Turning now to FIG. 3, a scenario is illustrated where dual mode device (“DM”) 18 enters the radio range 38 of access point device 26, which may be referred to as a WiFi router of home wireless local area network (“HWLAN”) 12. HWLAN 12 is the WLAN that the subscriber of services assigned to DM 18 has registered as his or her home WLAN. As known in the art, the transceiver of device 26 continuously generates a signal message indicating that HWLAN 12 is active. This signal, which may be referred to as a presence signal, received by DM 18 as indicated by encircled 1 in the figure, typically includes the Basic Service Set Identifier (“BSSID”) as known in the art, which is a unique identifier related to the media access control (“MAC”) address of wireless access point device 26.

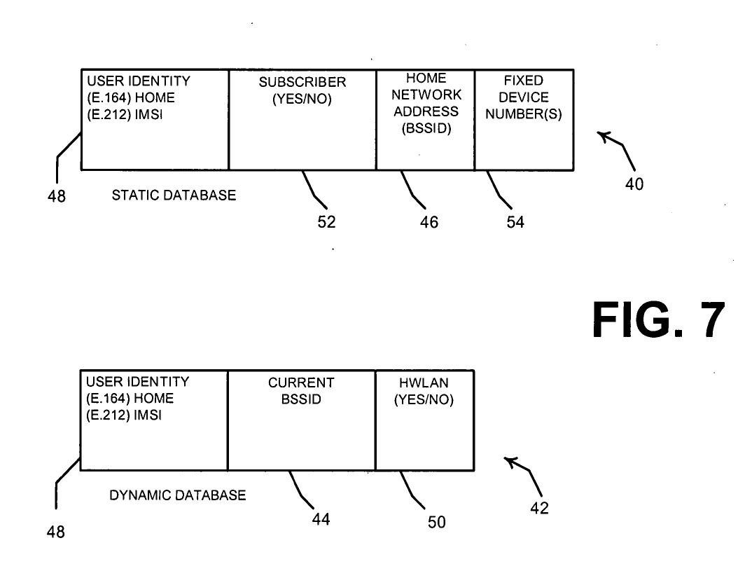

Upon receiving the presence signal from device 26, dual mode device 18 forwards the BSSID of device 26 to FMC server 28, or more specifically, to the WWC application server 30. The BSSID may be forwarded by dual mode device 18 via SIP MESSAGE, as known in the art. Another means for transporting BSSID information corresponding to the wireless network in which the dual mode device is currently present may include using P-Access-Network-Info which is known in the art for transmitting network type. However, use of the Access-Network-Info header to transmit a message like the BSSID is not known in the art.: The format of the message may be similar to the following—P-Access-Network-Info: IEEE-802.11b; bssid=aa:bb:cc:dd:ee:ff—where aa:bb:cc:dd:ee:ff is the BSSID, or MAC address of the wireless network access point device. It will be appreciated that other formats/protocols may also be used to transmit/forward the BSSID of the wireless LAN to application server 30, which may be on FMC server 28. AAC application server 30 will typically have been configured with a static database and a dynamic database, among other databases and applications. The static database is indexed on the subscriber's identity, and contains a field that identifies whether the user is a subscriber to fixed mobile convergence, a field that lists the HWLAN BSSID associated with the subscriber and a field that lists the number, or numbers that are associated with the BSSID—for example, the telephone number or numbers someone would dial to reach the home or office EMTA device to which the HWLAN is coupled. The static database structure is illustrated in FIG. 7.

FIG. 7 also shows a structure of dynamic database 42. Dynamic database 42 is updated with the BSSID of a WLAN when a user's dual mode device enters the range of the WLAN. Dynamic database also contains a field that identifies whether the HWLAN is the user's designated home WLAN, or HWALAN.

Thus, returning to description of FIG. 3, when the subscriber's DM 18 forwards the BSSID 39 of the WLAN access point device 26, of which range it has entered, as illustrated by encircled step 2, WWC server 30 processes the received data. The processing at WWC server 30 includes updating the dynamic database 42, as illustrated in FIG. 7. The current. BSSID field 44 is updated with the BSSID received from DM 18 at encircled step 2 shown in FIG. 3. WWC server 30 then determines whether the BSSID matches the BSSID corresponding to the subscriber's home WLAN, which HWLAN BSSID is stored in field 46 in static database 40 shown in FIG. 7. Accordingly, DM 18 and the number(s) of the EMTA device to which POTS device 27, or devices, is/are linked together via the BSSID of the HWLAN when the DM 18 has detected the presence of the WLAN designated by the user as his or her HWLAN.

This linking of the home wireless local area network and the subscriber's dual mode device provides convenience when dual mode device 18 is within the range of the designated home wireless LAN. It will be appreciated that the subscriber may change which wireless LAN is the home wireless LAN. For example, if the subscriber owns a second home, the subscriber may designate a wireless local area network as the HWLAN when the subscriber is at the second home for a weekend or extended vacation from the primary home.

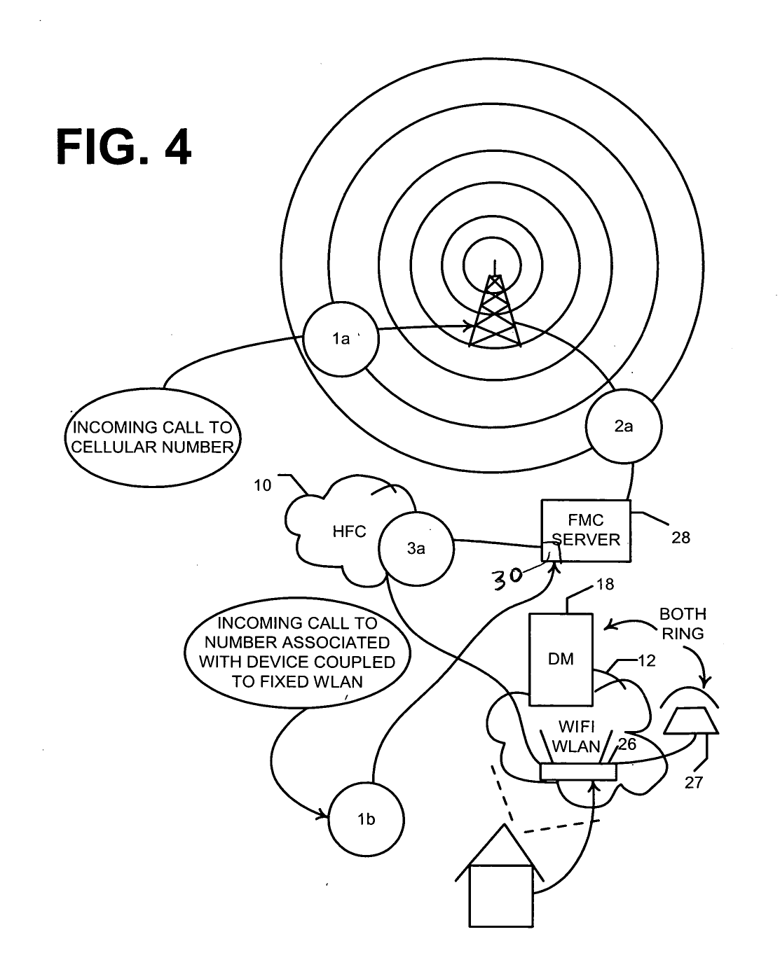

As shown in FIG. 4, the scenario illustrated in FIG. 3 is shown in the context of receiving outside calls placed to either dual mode device 18 or the EMTA to which devices 27 are coupled. These separate device(s), which have independent number(s) associated with them, may be referred to as a forking partner(s), since a call to one may be forked to the other for simultaneous ringing of both when a call is placed to either. Typical telephone dial plan numbers may be location specific—the term dial plan and number, as in telephone number, may be used interchangeably herein. It will be appreciated that WiFi LAN 12 is typically coupled to HFC 10 via an EMTA device, which along with many external components related to an HFC delivery system, such as, for example, a cable modem termination system (“CMTS”) are not shown in the figure for clarity. In addition, it will be appreciated that the other methods of delivery to the WiFi LAN 12 are possible, including, but not limited to, digital subscriber line (“DSL”) and broadband over power lines (“BPL”). Furthermore, network components, such as the public internet and managed internet, as illustrated in FIG. 1 are not shown in FIG. 4 for clarity. However, those skilled in the art will understand how the non-illustrated components interact and connect with the illustrated components.

FIG. 4 illustrates two scenarios that ring the telephony devices at the subscriber's designated ‘home.’ Thus, for purposes of discussion, it is assumed that WLAN 12 is the subscriber's (subscriber to services provided to DM (18)) designated ‘home’ LAN. In scenario a, an outside caller places a call to the number associated with DM device 18 at encircled step 1a. The call could be placed from another cellular device or from a POTS device coupled to the PSTN (not illustrated). Regardless of how or wherefrom the call is placed, the call is forwarded to WWC server 30 at encircled step 2a. It will be appreciated that reference to ‘the call’ includes call signaling, call set, call provisioning information, as known in the art, and may not include actual call content being forwarded to/through WWC server 30.

WWC server 30 determines that the user associated with user identity 48 shown in the database structures in FIG. 7 is a subscriber to fixed mobile convergence. WWC server 30 looks up the user identity in dynamic database 42 and determines that HWLAN 12 is the user's designated ‘home’ WLAN based on the value in current BSSID field 44 matching the value in Home Network Address (BSSID) field 46 in static database 40. It will be appreciated that HWLAN (yes/no) field 50 may already have been updated with a ‘yes’ when the presence within HWLAN 12 was detected and the HWLAN's BSSID was stored to dynamic database 42.

Upon determining that the subscriber's DM device 18 is within the range of his or her HWLAN 12, WWC application server 30 forwards at encircled step 3c the call to the HWLAN with instructions to ring both the POTS devices 27 coupled to wireless router 26 and dual mode device 18. Thus, if the user has placed DM device 18 into a charger, or is not near the dual mode device to hear it ring, the subscriber does not miss the call because the POTS devices 27 also ring.

Similarly, if an outside caller calls at encircled step 1b the ‘home number’ associated with the EMTA device coupled to POTS devices 27, the call is processed as any call received at the EMTA would be to the POTS devices. However, before the call is forwarded to the HFC, DSL network, the BPL network, etc., WWC application server 30 determines that the user subscribes to fixed mobile convergence by evaluating Subscriber (yes/no) field 52 in static database 40. Upon determining that the user identified in field 48 is a subscriber to fixed mobile convergence, WWC 30 determines whether the subscriber's DM 18 is within the presence of the HWLAN 12 by evaluating field 50 of dynamic database 42. If field 52 of static database 40 is yes and field 50 of dynamic database is yes, then the call is forwarded with instructions to ring both DM 18 and EMTA-coupled POTS devices 27. Thus, the subscriber's convenience is increased because if the subscriber has DM 18 with them outdoors, for example, where they would not likely hear the POTS devices 27 ring, the call can still be answered because the DM device will also ring.

It will be appreciated that parts of static database 40 shown in FIG. 7 may be modified by the subscriber. For example, the user may be on vacation at a second home and wish to designate the WLAN and the HWLAN in field 46. The number(s) associated with the fixed devices, typically POTS devices connected to the EMTA component of wireless access device 26 typically do not change, as these are managed by the local service providers. However, the wireless LAN router 26 and POTS devices 27 need not be transported from location to location to facilitate operation of the presence sensing feature. The user may reconfigure the WLAN to be used as the ‘home’ wireless LAN using a simple browser application interface.

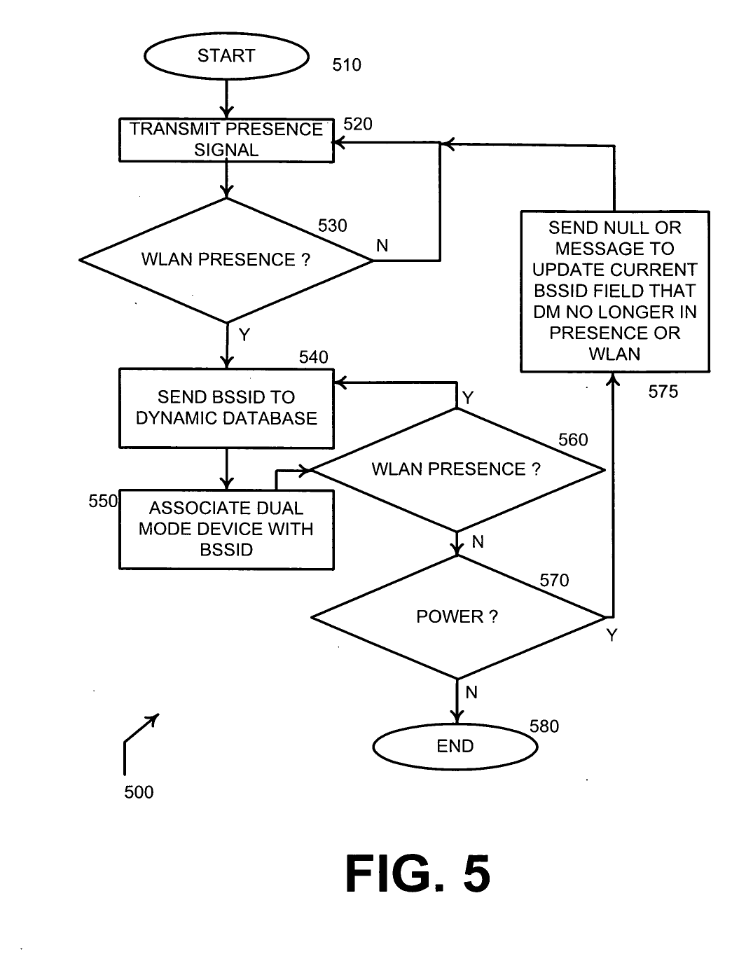

Turning now to FIG. 5, a flow diagram illustrates a method 500 that starts at step 510. When a dual mode device enters the range of a wireless LAN the dual mode devices determines that it is within the presence of the WLAN. The presence within the WLAN range is facilitated by the reception of a signal that the WLAN periodically transmits at step 520. The transmitted signal includes the BSSID of the WLAN access point, typically a wireless router that is coupled to, or integrated with, a device such as a cable modem/EMTA device that couples to a broadband network. The dual mode device is designed to constantly monitor for a presence signal. The wireless access point device transmits the presence signal periodically at a period that may be set to a predetermined value within a range by the subscriber/user.

Until a presence signal is detected at step 530, method 500 returns to step 520. When a presence signal is received from a wireless access point device by the dual mode device, a determination is made at step 530 that the dual mode device is within the presence of a wireless access point device and the dual mode device transmits the BSSID received in the presence signal in a message, such as, for example, in a P-Access-Network-Info header to an WWC application server at step 540. The BSSID message may be sent over a cellular network, or preferably, via the wireless LAN-coupled EMTA device that is referred to herein as part of the wireless access point device, the presence of which the dual mode device is in. The WWC application server receives the BSSID message and updates a record in a dynamic database at step 550.

The record that is updated is the record that corresponds to the dual mode device user based on his or her identity. Thus, the user identity associated with the dual mode device is associated with the BSSID of the wireless LAN, the presence signal of which the dual mode device detected at step 530. Accordingly, the numbers associated with the wireless LAN that was detected at step 530 and the dual mode device number are linked together via the BSSID of the wireless LAN.

At step 560, the dual mode device determines whether it is still within the presence of the wireless LAN based on whether a presence message has been received from the wireless LAN within a predetermined period that occurs at a predetermined refresh rate. If the dual mode device has detected a presence signal within a predetermined period, method 500 returns to step 540 and send the BSSID of the detected presences message to the FMC again. If the dual mode device does not detect a presence message from a wireless LAN within the preceding predetermined period a determination is made whether power to the dual mode device has been disabled at step 570. If power is still supplied, a null value in place of a BSSID is sent to the FMC server to replace the previously stored BSSID in the dynamic database. Then, method 500 returns to step 520. It will be appreciated that instead of a null value to replace the value in the current BSSID field in the dynamic database, a message may be sent to the WWC application server instructing that the value stored in the current BSSID field be erased. Either embodiment accomplishes the same function of updating the current BSSID field in the same way by sending information to the FMC server with the same result that the BSSID field in the dynamic database reflects that the dual mode device is no longer in the presence of a WLAN.

If power to the dual mode device has been removed there from, method 500 ends at step 580. Therefore, the BSSID of the WLAN is periodically transmitted to the FMC server at the predetermined rate. When the dual mode device leaves the presence of the WLAN, the dual mode device will attempt to detect presence at step 560. Detecting no presence, the dual mode device will send the null message no longer be associated with the WLAN and the numbers associated therewith. Otherwise, if this continual updating did not occur, the HWLAN devices would ring when the dual mode device number was dialed even when the dual mode device is not within the presence of the HWLAN.

It will be appreciated the wireless LAN access point device periodically transmits a presence signal and the dual mode device also monitors for a presence signal at predetermined refresh rate. The wireless LAN typically transmits a presence signal at a rate much higher then the refresh rate at which the dual mode device monitors for a signal. For example, the wireless LAN access point device may transmit a presence signal once every 100 milliseconds and the dual mode device may be programmed by the user to monitor for presence for one second at a refresh rate of once every five minutes. The longer the refresh rate, the less battery power is used by the dual mode device.

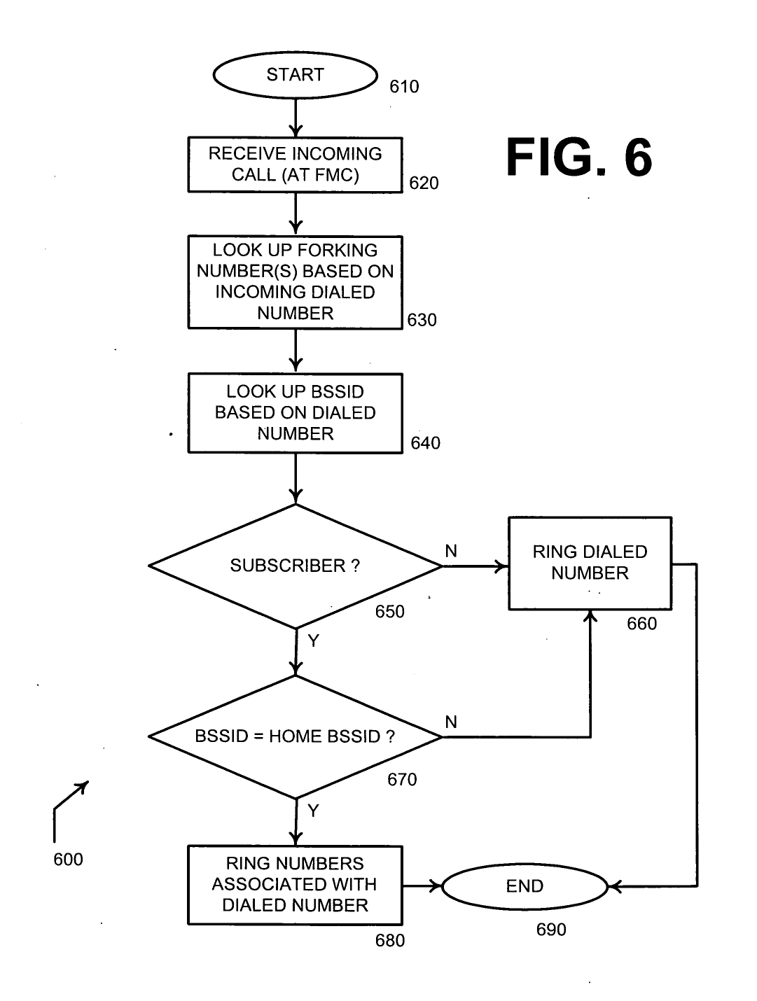

Turning now to FIG. 6, a method 600 for ringing devices associated with forking partner numbers when one of the forking numbers is dialed is shown. The number(s) associated with the devices coupled to a wireless LAN are (previously) stored in field 54 of static database 40 shown in FIG. 7. Process 600 starts at step 610. A message that a call has been placed is received at a WWC at step 620. A lookup is performed at step 630 by the WWC for forking partners associated with the number dialed. If the number dialed is a dual mode device, the WWC may determine the user identity associated with the number dialed from dynamic database 42 shown in FIG. 7, and look in field 54 of static database 40 to determine forking partner numbers. Alternatively, if the number dialed is a device coupled to a wireless LAN as listed in field 54 of static database 40, the corresponding user identity is used to determine the dual mode device associated with the user identifier.

At step 640 the WWC uses the identity associated with the dialed number to determine the current BSSID from field 44 of dynamic database 42.

At step 650, a determination is made whether the subscriber associated with the identity that is associated with the dialed number is a subscriber to fixed mobile convergence from the service provider, typically the service provider of the network to which the wireless LAN/EMTA device couples and/or the cellular network. Furthermore, the determination at step 650 determines whether the subscriber subscribes to dynamic association of the dual mode device with the home wireless LAN. The service provider may not be a single company, but multiple companies that agreed to work with one another to provide interoperability of their respective services, such as, For example, an agreement between a cellular services provider and a cable MSO.

If at step 650 the subscriber is determined not to be a subscriber to fixed mobile convergence, the WWC server causes the corresponding system, either cellular or wireless LAN, to ring the number dialed at step 660. If the subscriber is determined at step 650 to be a subscriber that subscribes to (device(s) is/are provisioned for) fixed mobile convergence, a determination is made at step 670 whether the BSSID in field 44 of the record of dynamic database 42 corresponding to the user identity associated with the number dialed is the subscriber's home wireless LAN, or HWLAN. The determination at step 670 essentially compares the contents of field 44 of database 42 to field 46 of database 40 for records corresponding to the user identifier associated with the number dialed. If the comparison is false, or no, meaning the contents of the compared fields are not the same, the WWC application server causes the corresponding system, either cellular or wireless LAN, to ring the number dialed at step 660. If the comparison at step 670 is true, meaning that the contents of the compared fields are the same, the WWC server causes the systems corresponding to the numbers linked via the BSSID to distribute the call to all the linked numbers, thus ringing all the devices associated with the linked numbers at step 680. The process ends at step 690.

WWC server 30 may be collocated with FMC server 28, which is typically connected to the managed IP network as shown in FIG. 1, however the WWC may be located elsewhere in network 2. Application server software loaded on the WWC server communicates with a telephony soft switch, which is typically coupled to the managed network, and the FMC server. Thus, the WWC application server software processes all calls, whether the dialed number is the dual mode device or the number(s) of the EMTA at the subscriber's home that are coupled to the home wireless LAN.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A system for dynamically associating a subscriber device of a subscriber with a first network, comprising:
means for detecting the presence of the subscriber device within the first network, the first network being associated with a network identifier;
means for sending the network identifier to a wireless wireline convergence application server upon detection by the subscriber device of its presence within the first network; and
means for associating the network identifier with the subscriber device at the converged service gateway so that a dial plan associated with the subscriber device and a dial plan associated with devices coupled to the fist network are linked via the first network identifier.

2. The system of claim 1 wherein the first network is a local network.

3. The system of claim 2 wherein the local network is a wireless network.

4. The system of claim 3 wherein the wireless network is a Wi-Fi network.

5. The system of claim 1 wherein the first network identifier is a MAC address.

6. The system of claim 3 wherein the first network identifier is the BSSID of a wireless network access point device.

7. The system of claim 1 wherein the subscriber device is a dual mode device.

8. The system of claim 1 further comprising:
means for receiving at the first network a call dialed from a second network;
means for determining whether the number dialed is provisioned for dynamic association with the first network when present therein;
means for determining numbers of forking partners associated with the subscriber device; and
means for distributing a call to devices associated with the number dialed.

9. The system of claim 8 wherein the number dialed is the number of the subscriber device.

10. The system of claim 8 wherein the number dialed is a number of a device associated with the first network.

11. The system of claim 1 wherein the means for sending the network identifier to a converged services gateway is adapted to periodically monitor for presence within a wireless local area network at a predetermined rate.

12. The system of claim 11 wherein the means for sending the network identifier to a converged services gateway is adapted to send a null value in place of a BSSID to the converged service gateway when presence within the range of a wireless local area network is not detected at one of the periodic monitoring instances.

13. A method for dynamically associating a subscriber device of a subscriber with a first network, comprising:
step for detecting the presence of the subscriber device within the first network, the first network being associated with a network identifier;
step for sending the network identifier to a wireless wireline convergence application server upon detection by the subscriber device of its presence within the first network; and
step for associating the network identifier with the subscriber device at the converged service gateway, so that a dial plan for the subscriber device and a dial plan for devices coupled to the fist network are linked via the first network identifier.

14. The method of claim 13 wherein the first network is a local network.

15. The method of claim 14 wherein the local network is a wireless network.

16. The method of claim 15 wherein the wireless network is a Wi-Fi network.

17. The method of claim 13 wherein the first network identifier is a MAC address.

18. The method of claim 15 wherein the first network identifier is the BSSID of a wireless network access point device.

19. The method of claim 13 wherein the subscriber device is a dual mode device.

20. The method of claim 13 further comprising:
step for receiving at the first network a call dialed from a second network;
step for determining whether the number dialed is provisioned for dynamic association with the first network when present therein;
step for determining distribution numbers of forking partners associated with the subscriber device; and
step for distributing a call to devices associated with the number dialed.

21. The method of claim 20 wherein the number dialed is the number of the subscriber device.

22. The method of claim 20 wherein the number dialed is a number of a device associated with the first network.

23. The method of claim 13 wherein the step for sending the network identifier to a converged services gateway is occurs periodically to monitor for presence within a wireless local area network at a predetermined rate.

24. The method of claim 23 wherein the step for sending the network identifier to a converged services gateway includes sending a null value in place of a BSSID to the converged service gateway when presence within the range of a wireless local area network is not detected at one of the periodic monitoring instances.

25. The method of claim 13 where the network identifier is sent in a P-Access-Network-Info header.
